(19) United States
(12) Patent Application Publication
(10) Pub. No.: US 2005/0111498 A1
(43) Pub. Date: May 26, 2005

(54) Mode behavior of single-mode semiconductor lasers

(76) Inventors: Andrew J. Daiber, Emerald Hills, CA (US); Sergei L. Sochava, Sunnyvale, CA (US); William B. Chapman, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/881,866

(22) Filed: Jun. 30, 2004

Related U.S. Application Data
(60) Provisional application No. 60/524,510, filed on Nov. 24, 2003.

(51) Int. Cl. H01S 3/10

(52) U.S. Cl. 372/20; 372/92

(57) ABSTRACT

Mode behavior of single longitudinal mode semiconductor lasers are modeled and employed for configuring external cavity lasers, including external cavity diode lasers (ECDLs). In particular, equations employed for modeling active and passive mode pulling effects are derived, and the equations are combined to formulate an equation corresponding to an optimal operating condition under which longitudinal lasing mode stability is enhanced. Under the optimal condition, the laser will operate in a lasing mode with the lowest threshold losses that is also stable. Based on the equation, a full-width-half maximum (FWHM) value for in intracavity filter can be selected to enable the laser to operate under or approach the optimal operating condition.

### CROSS-REFERENCE TO RELATED APPLICATIONS

The present application is based on a co-pending provisional application entitled “MODE BEHAVIOR OF SINGLE-MODE SEMICONDUCTOR LASERS,” Ser. No. 60/524510, filed on Nov. 24, 2003, the benefit of the filing date of which is claimed under 35 U.S.C. § 119(e).

### FIELD OF THE INVENTION

The field of invention relates generally to optical communication systems and, more specifically but not exclusively relates to enhanced tunable lasers and methods for providing enhanced channel switching in such tunable lasers.

### BACKGROUND INFORMATION

There is an increasing demand for tunable lasers for test and measurement uses, wavelength characterization of optical components, fiberoptic networks and other applications. In dense wavelength division multiplexing (DWDM) fiberoptic systems, multiple separate data streams propagate concurrently in a single optical fiber, with each data stream created by the modulated output of a laser at a specific channel frequency or wavelength. Presently, channel separations of approximately 0.4 nanometers in wavelength, or about 50 GHz are achievable, which allows up to 128 channels to be carried by a single fiber within the bandwidth range of currently available fibers and fiber amplifiers. Greater bandwidth requirements will likely result in smaller channel separation in the future.

DWDM systems have largely been based on distributed feedback (DFB) lasers operating with a reference etalon associated in a feedback control loop, with the reference etalon defining the ITU wavelength grid. Statistical variation associated with the manufacture of individual DFB lasers results in a distribution of channel center wavelengths across the wavelength grid, and thus individual DFB transmitters are usable only for a single channel or a small number of adjacent channels.

Continuously tunable external cavity lasers have been developed to overcome the limitations of individual DFB devices. Various laser-tuning mechanisms have been developed to provide external cavity wavelength selection, such as mechanically tuned gratings used in transmission and reflection. External cavity lasers must be able to provide a stable, single mode output at selectable wavelengths while effectively suppress lasing associated with external cavity modes that are within the gain bandwidth of the cavity. These goals have been difficult to achieve, and there is accordingly a need for an external cavity laser that provides stable, single mode operation at selectable wavelengths.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1a is a schematic diagram of a generalized external cavity laser for which various embodiment of the invention may be derived in accordance with the teachings and principles disclosed herein;

FIG. 1b is a schematic diagram illustrating a laser cavity defined by a partially-reflective front facet of a Fabry-Perot gain chip and a reflective element;

FIG. 2 is a diagram illustrating a relative position of a laser cavity's lasing modes with expect to transmission peaks defined by an intra-cavity etalon and channel selector;

FIG. 3 is a diagram illustrating choices for the transmission curves of an intracavity filter;

FIG. 4a is a diagram illustrating the transmission amplitude and the argument of the transmission phase shift through an etalon filter;

FIG. 4b is a diagram illustrating the transmission amplitude and the argument of the transmission phase shift through a different etalon filter;

FIG. 4c is a diagram illustrating the transmission amplitude and the argument of the transmission phase shift through a third etalon filter;

FIG. 5a is a diagram illustrating an etalon along with a series of transmitted beams distinguished by the number of reflections each takes off the etalon surfaces;

FIG. 5b is a diagram illustrating the phasor sum of the transmitted beams;

FIGS. 6a-c are graphs of optical filter transmission vs. frequency used to illustrate a change in lasing mode frequency due to active and passive mode pulling effects;

FIG. 7 is a schematic diagram of an external cavity diode laser (ECDL) in accordance with one embodiment of the invention that may be configured to produce a highly-stable single longitudinal lasing mode;

FIG. 8 is a schematic diagram of an ECDL illustrating further details of a channel selection scheme that employs a pair of adjustable etalons;

FIG. 9 is a schematic diagram illustrating an overview of an ECDL in which a gain medium chip with a bent waveguide is employed; and

FIG. 10 is a schematic diagram of a communication network including a network switch in which tunable external cavity lasers in accordance with embodiments of the invention may be deployed.

### DETAILED DESCRIPTION OF PREFERRED EMBODIMENTS

Embodiments of methods for configuring intracavity filters for external cavity lasers in view of the mode behavior of single longitudinal mode semiconductor lasers and apparatuses employing the filter configurations are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

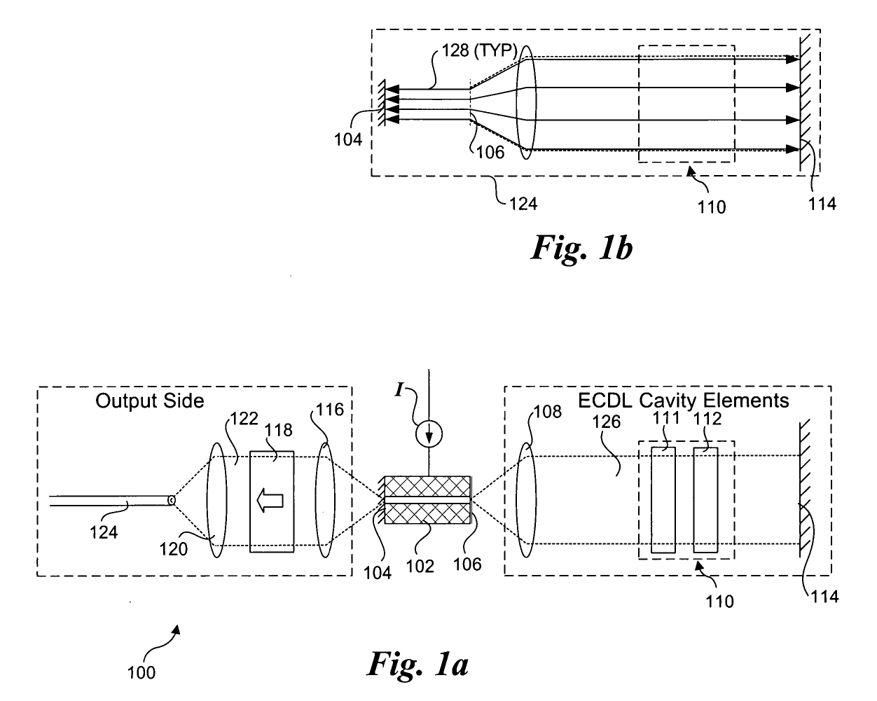

Discrete wavelength tunable diode lasers typically comprise a semiconductor gain medium, two reflectors, and an intra-cavity tuning mechanism. For example, as an overview, a generalized embodiment of an external cavity diode laser (ECDL) 100 is shown in FIG. 1. ECDL 100 includes a gain medium comprising a diode gain chip 102. Diode gain chip 102 comprises a Fabry-Perot diode laser including a partially-reflective front facet 104 and an anti-reflective rear facet 106 coated with an anti-reflective (AR) coating to minimize reflections at its face. Optionally, diode gain chip 102 may comprise a bent-waveguide structure on the gain medium to realize the non-reflective rear facet 106. The external cavity elements include a diode intracavity collimating lens 108, tuning filter element or elements 110, and a reflective element 114. In general, reflective element 114 may comprise a mirror, grating, prism, or other reflector or retroreflector, which may also provide the tuning filter function in place of tuning element 110. The output side components include a diode output collimating lens 116, an optical isolator 118, and a fiber focusing lens 120, which focuses an output optical beam 122 such that it is launched into an output fiber 124.

The basic operation of ECDL 100 is a follows. A controllable current I is supplied to diode gain chip 102 (the gain medium), resulting in a voltage differential across the diode junction, which produces an emission of optical energy (photons). The emitted photons pass back and forth between partially-reflective front facet 104 and reflective element 114, which collectively define the ends of an “effective” laser cavity (i.e., the two reflectors discussed above), as depicted by laser cavity 126 in FIG. 1b. As the photons pass back and forth, a plurality of resonances, or “lasing” modes are produced. Under a lasing mode, a portion of the optical energy (photons) temporarily occupies the external laser cavity, as depicted by intracavity optical beam 126 and light rays 128; at the same time, a portion of the photons in the external laser cavity eventually passes through partially-reflective facet 104.

Light comprising the photons that exit the laser cavity through partially-reflective front facet 104 passes through diode output collimating lens 116, which collimates the light into output beam 122. The output beam then passes through optical isolator 118. The optical isolator is employed to prevent back-reflected light from being passed back into the external laser cavity, and is generally an optional element. After the light beam passes through the optical isolator, it is launched into the output fiber 124 by fiber focusing lens 120. Generally, output fiber 124 may comprise a polarization-preserving type or a single-mode type such as SMF-28.

Through appropriate modulation of the input current (generally for communication rates of up to 2.5 GHz) or through modulation of an external element disposed in the optical path of the output beam (not shown) (for 10 GHz and 40 GHz communication rates), data can be modulated on the output beam to produce an optical data signal. Such a signal may be launched into a fiber and transmitted over a fiber-based network in accordance with practices well known in the optical communication arts, thereby providing very high bandwidth communication capabilities.

The lasing mode of an ECDL is a function of the total optical path length between the cavity ends (the cavity optical path length); that is, the optical path length encountered as the light passes through the various optical elements and spaces between those elements and the cavity ends defined by partially-reflective front facet 104 and reflective element 114. This includes diode gain chip 102, diode intracavity collimating lens 108, tuning filter element(s) 110, plus the path lengths between the optical elements (i.e., the path length of the transmission medium occupying the ECDL cavity, which is typically a gas such as air). More precisely, the total optical path length is the sum of the path lengths through each optical element and the transmission medium times the coefficient of refraction for that element or medium.

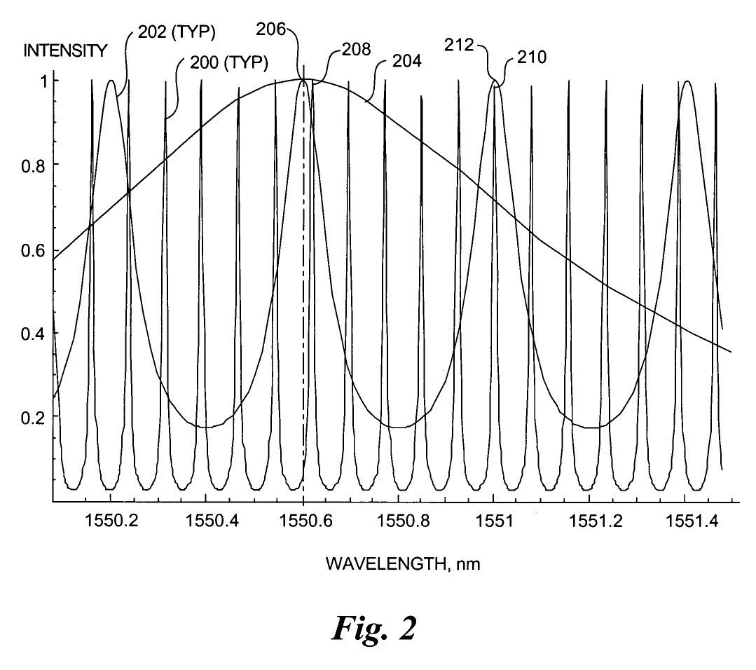

As discussed above, under a lasing mode, photons pass back and forth between the cavity end reflectors at a resonance frequency, which is a function of the cavity optical path length. In fact, without the tuning filter elements, the laser would resonate at multiple frequencies. Longitudinal laser modes occur at each frequency where the roundtrip phase accumulation is an exact multiple of 2π. For simplicity, if we model the laser cavity as a Fabry-Perot cavity, these frequencies can be determined from the following equation:

$$L = \frac{λ x}{2 n} \qquad ( 1 )$$

where λ=wavelength, L=optical length of the cavity, x=an arbitrary integer −1, 2, 3, . . . , and n=refractive index of the medium. The average frequency spacing can be derived from equation (1) to yield:

$$Δ v = \frac{c}{2 L} \qquad ( 2 )$$

where ν=c/λ and c is the speed of light. The number of resonant frequencies is determined from the width of the gain spectrum. The corresponding lasing modes for the cavity resonant frequencies are commonly referred to as “cavity modes,” an example of which is depicted by cavity modes 200 in FIG. 2.

Semiconductor laser gain media typically have broad gain spectra and therefore require spectral filtering to achieve longitudinal mode operations (i.e., operations at a single wavelength or frequency). In order to produce an output at a single frequency, filtering mechanisms are employed to substantially attenuate all lasing modes except for the lasing mode corresponding to the desired frequency. As discussed above, in one scheme a pair of etalons, depicted as a grid generator 111 and a channel selector 112 in FIG. 1. The grid generator, which comprises a static etalon that operates as a Fabry-Perot resonator, defines a plurality of transmission peaks (also referred to as passbands) in accordance with equations (1) and (2). Ideally, during operation the transmission peaks remained fixed, hence the term “static” etalon; in practice, it may be necessary to employ a servo loop (e.g., a temperature control loop) to maintain the transmission peaks at the desired location. Since the cavity length for the grid generator is less than the cavity length for the laser cavity, the spacing (in wavelength) between the transmission peaks is greater for the grid generator than that for the cavity modes.

A set of transmission peaks 202 corresponding to an exemplary etalon grid generator is shown in FIG. 2. Note that at the peaks of the waveform the intensity (relative in the figure) is a maximum, while it is a minimum at the troughs. Generally, the location and spacing of the transmission peaks for the grid generator will correspond to a set of channel frequencies defined by the communication standard the laser is to be employed for, such as the ITU channels and 0.04 nanometer (nm) spacing discussed above and depicted in FIG. 2. Furthermore, the spacing of the transmission peaks corresponds to the free spectral range (FSR) of the grid generator.

As discussed above, a channel selector, such as an adjustable etalon, is employed to select the lasing mode of the laser output. For illustrative purposes, in one embodiment channel selector 112 may comprise an etalon having a width substantially less than the etalon employed for the grid generator. In this case, the FSR of the channel selector is also substantially greater than that of the grid generator; thus the bandpass waveform of the channel selector is broadened, as illustrated by channel selector bandpass waveform 204 having a single transmission peak 206. In accordance with this channel selection technique, a desired channel can be selected by aligning the transmission peak of the channel selector (e.g. 206) with one of the transmission peaks of the grid generator. For example, in the illustrated configuration depicted in FIG. 2, the selected channel has a frequency corresponding to a laser output having a 1550.6 nm wavelength.

In addition to the foregoing scheme, several other channel selecting mechanisms may be implemented, including rotating a diffraction grating; electrically adjusting a tunable liquid crystal etalon; mechanically translating a wedge-shaped etalon (thereby adjusting its effective cavity length); and “Vernier” tuning, wherein etalons of the same finesses and slightly different FSRs are employed, and a respective pair of transmission peaks from among the transmission peaks defined by the etalons are aligned to select the channel in a manner similar to that employed when using a Vernier scale.

Note that in the illustrated example of FIG. 2, the transmission peak 208 of the cavity mode nearest the selected channel is misaligned with the transmission peaks for the grid generator and channel selector. As a result, the intensity of the laser output is attenuated due to the misalignment, which is reflected in the form of cavity losses. Various mechanisms may be employed to shift the cavity mode transmission peaks such that they are aligned with the grid generator and channel selector transmission peaks, thus yielding a maximum intensity in the laser output. Generally, under such schemes the optical path length of the laser cavity is adjusted so that it equals a multiple half-wavelength (λ/2) of the transmission wavelength selected by the grid etalon and channel selector (i.e., the wavelength at which grid etalon and channel selector transmission peaks are aligned). In one embodiment known as “wavelength locking,” an electronic servo loop is implemented that employs a modulated excitation signal that is used to modulate the overall cavity optical path length, thereby producing wavelength and intensity modulations in the laser output. A detection mechanism is employed to sense the intensity modulation (either via a measurement of the laser output intensity or sensing a junction voltage of the gain medium chip) and generate a corresponding feedback signal that is processed to produce a wavelength error signal. The wavelength error signal is then used to adjust the unmodulated (i.e., continuous) overall cavity optical path length so as to align the transmission peak of the cavity mode with the transmission peaks of the grid generator and channel selector.

As discussed above, spectral filtering is employed for single mode operation of ECDLs. The filtering perturbs the laser mode positions, both passively, through phase shifts associated with the filter, and actively, through effects involving the gain medium. These effects are further discussed below with respect to experimental data that were obtained using an external cavity laser operating near 1550 nm with an InGaAsP gain media in which the cavity length, and hence mode position, can be varied independently from the filter transmission peak.

Passive Mode Pulling

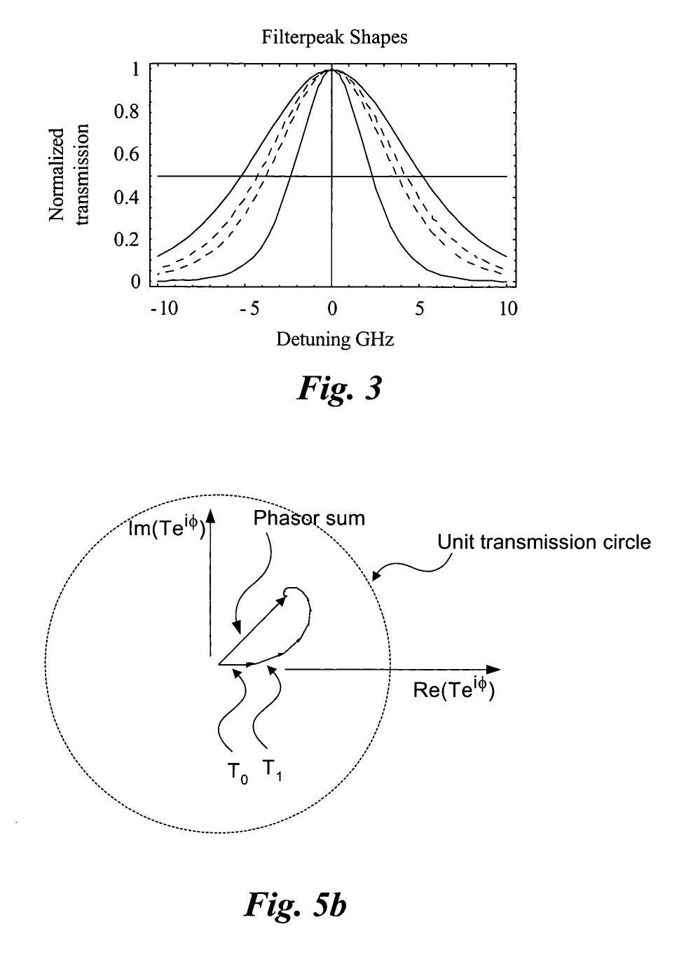

FIG. 3 shows normalized transmission curves for a typical set of spectral filters. Using theoretical behavior, each peak is symmetrical about a tuning frequency for the filter (that is, the frequency for which the filter is tuned). As the frequency is detuned, the transmission of light through the filter is reduced. The shape of the normalized transmission curves are defined by their full-width-half maximum (FWHM) value, which narrows as the filter's mirror reflectivity is increased. The filter's finesse is equal to the filter's free spectral range divided by its FWHM. The four curves shown have FWHM values of 4.66 GHz, 7.54 GHz, 8.54 GHz, and 10.37 GHz in order of increasing width.

A “mode hop” occurs when a new lasing mode becomes more favored than the existing laser mode. Typically, one assumes this occurs when the roundtrip losses of the new laser mode becomes less than the roundtrip losses of the existing laser mode. This may not be the reason at all. If the filter FWHM is narrow enough relative to the mode spacing at which the laser modes become dynamically unstable, then the existing laser mode simply vanishes and the laser hops to the stable mode with the lowest roundtrip losses. Cavities can thus be divided into two classes: those that hop to a new mode when roundtrip losses become equal and those that hop to a mode with higher roundtrip losses when the operating mode becomes unstable.

One phenomenon that affects filter behavior (and ultimately, mode hope) is called “passive mode pulling.” The terminology “mode pulling” refers to the phenomenon where extra phase accumulation “pulls” the filter's resonance modes closer to one another. The term “passive” refers to optical elements that do not consume energy, such as electrical energy, during their operation and the properties of those optical elements (as to contrast to “active mode pulling” discussed below).

Returning to equations (1) and (2), let us now assume that an intracavity filter with a transmission function T(ν) (i.e., transmission of the filter vs. frequency ν) is used and that the laser lases at a single frequency near the transmission maximum of the filter. By the Kramers-Kronig relation, the transmission function T(ν) is complex valued where the argument, φ(ν), gives the phase shift of light transmitted by the filter. The phase slope, dφ/dν, causes extra phase accumulation with respect to frequency for the roundtrip light and causes the laser mode spacing to decrease. The passive mode pulling can then be converted into a length scale:

$${L}_{P} = \frac{c}{2 π} \frac{ⅆ ϕ}{ⅆ v} . \qquad ( 3 )$$

For many practical filter functions, the phase slope is relatively constant near the transmission peak where lasing has been assumed to occur. In these cases, L_{P} can be considered to be substantially constant, independent of frequency. The effect of the passive mode pulling is to locally reduce the longitudinal mode spacing to

$$Δ v = \frac{c}{2 ( L + {L}_{p} )} \qquad ( 4 )$$

near the transmission peak. As an example, a 15 mm cavity has a nominal mode spacing of 10 GHz. An etalon based filter having FWHM of 10 GHz and Lorentzian transmission profile, has a length scale of L_{P}=7.5 mm associated with it. Placed in the cavity, this filter will reduce the mode spacing to 6.7 GHz near the filter peak.

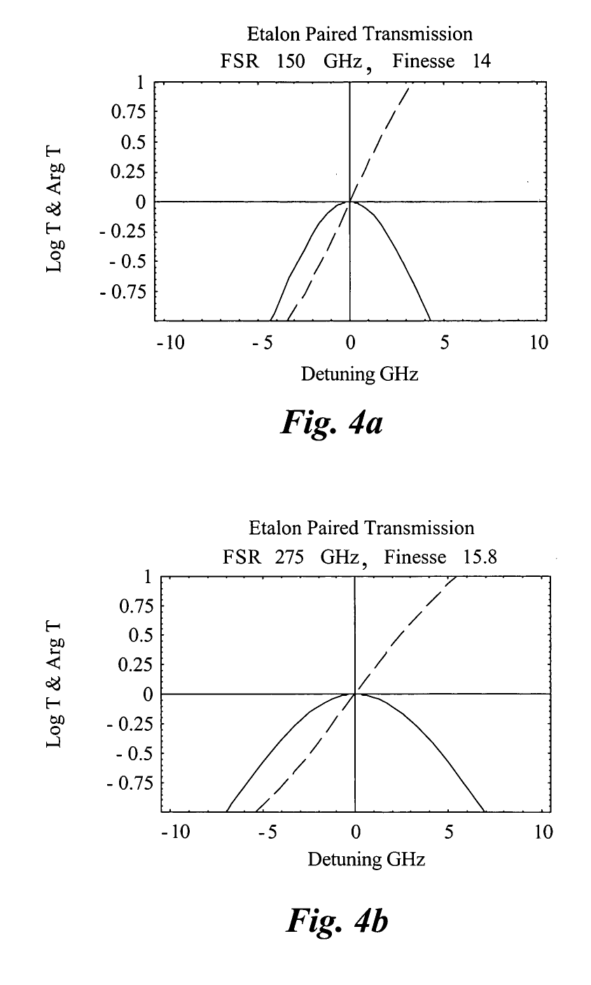

FIGS. 4a, 4b, and 4c show log transmission and phase shift curves for etalons having free spectral ranges of 150 GHz, 275 GHz, and 375, GHz, respectively. Within the detuning range that typically exists for laser operation, the phase shift is substantially linear, with the slope generally decreasing with an increase in FSR. From a laser design standpoint, the passive mode spacing may be treated as a constant.

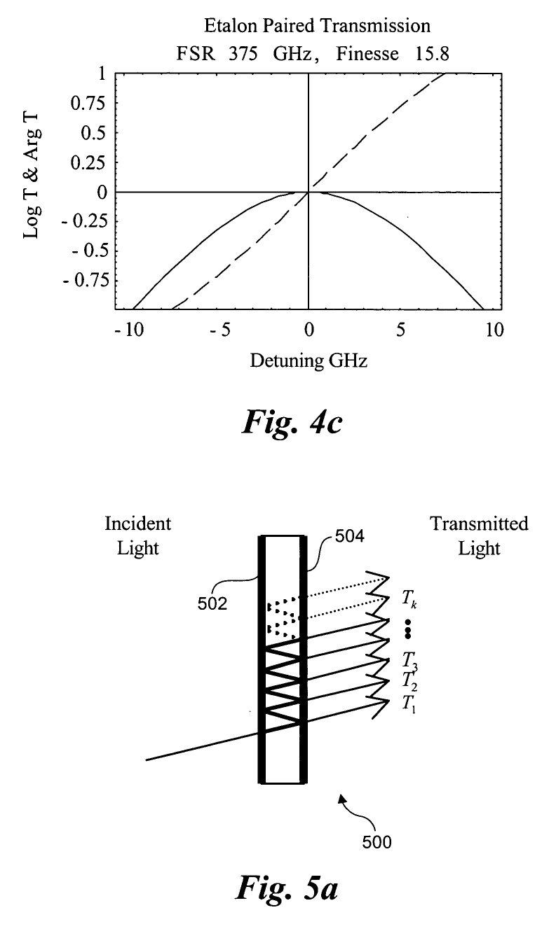

The reason for the phase accumulation is illustrated in FIG. 5a, which represents the path (exaggerated) of various photons that pass through an etalon 500. The faces 502 and 504 of etalon 500 function as cavity mirrors with a relatively low reflectivity. However, the reflectivity is high enough to cause the various photons to make one or more excursions between faces 502 and 504 before exiting as transmitted light. With each extra excursion, a corresponding phase shift is produced, adding to the accumulation of phase shift. A mode occurs every time the cavity accumulates π phase (i.e., another half λ is added to the cavity). The total transmission through the etalon is the sum of all the individual transmission contributions Tᵢ(ν), i=0, 1, . . . .

FIG. 5b shows the phasor sum of the complex valued Tᵢ(ν), i=0, 1, . . . in the complex plane. The total transmission amplitude and phase is the vector connecting the tail and head of the phasor sum. If the individual transmission contributions lined up in phase, then the total transmission would lie along the real axis and be maximized. The maximum transmission for low loss etalons is unity (100%). For the case shown, the transmission contributions do not line up in phase, and the total transmission is both reduced in amplitude and also shifted in phase relative to the real axis. Light passing through the etalon thus accumulates extra phase when that light is detuned from the frequency of maximum transmission. This extra phase accumulation through the intra-cavity filter causes the light executing a round trip of the laser cavity to accumulate 2π of phase faster than would otherwise be expected, causing the laser cavity modes to occur more frequently. The transmission peak of the filter is said to “pull” the laser modes closer together.

Active Mode Pulling

Active mode pulling arises when transmission losses through the intracavity filter interact with the gain medium to change the cavity length. The primary mechanisms are thermal effects and the linewidth enhancement factor. To illustrate the interactions, consider a laser operating in constant power mode. If the laser is detuned away from the filter transmission peak, the bias current must be increased to maintain output power. An unintended side effect to this is increased heating of the gain medium. This heating increases the optical path length of the gain media, lowering the lasing frequency, and further changing the detuning between laser mode and filter transmission peak.

The linewidth enhancement factor is the industry standard term for expressing the fact that optical gain of semiconductor laser materials is a complex quantity—gain (mathematically equivalent to an imaginary index of refraction) and index of refraction are intimately linked. The linewidth enhancement factor is simply the proportionality between the real and imaginary gain at a given lasing frequency. To understand the impact on laser operation, recall that gain=loss for all operating lasers. If the laser is detuned away from the filter transmission peak, increasing loss, then the optical gain also increases. The increased gain lowers the refractive index of the gain material, decreasing cavity length and further changing the detuning between laser mode and filter transmission peak.

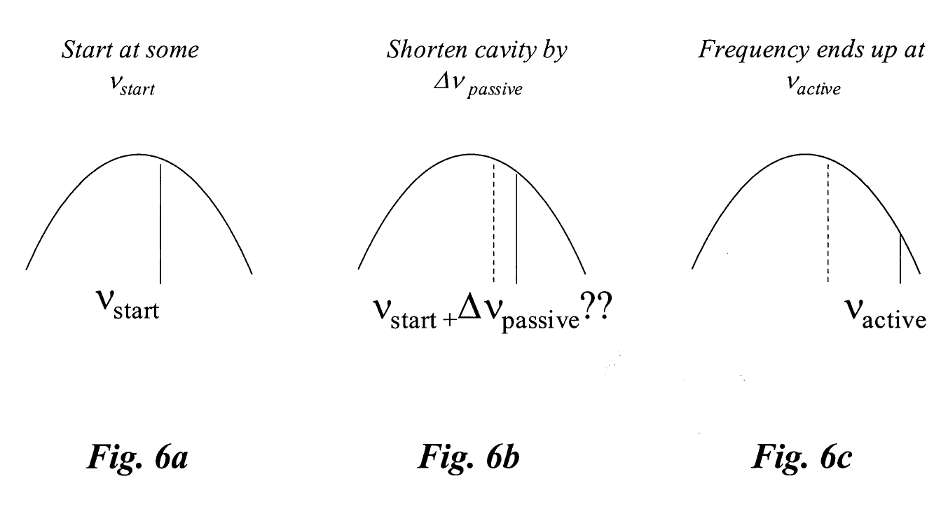

A schematic representation of the effects of passive and active mode pulling are depicted via FIGS. 6a, 6b, and 6c. The lasing condition begins at a starting frequency νₛₜₐᵣₜ, which is slightly offset from the center frequency corresponding to an optimally-tuned condition. In FIG. 6b, the cavity is shortened due to passive mode pulling in accordance with equation (3). This results in a positive shift in the lasing frequency by an amount of Δνₚₐₛₛᵢᵥₑ, as defined by equation (4).

The effect of the change in frequency reflects an increase in losses for the laser cavity. To compensate for this, the bias drive current to the gain medium is increased, which increases the temperature of the gain medium due to the generation of heat from the increased drive current. This, in turn, causes the optical path length of the gain medium to increase, resulting in a commensurate increase in the optical path length of the laser cavity. The proportionality between the optical path length and filter transmission loss caused by this thermal effect is captured with the following definition:

$${α}_{thermal} ≡ \frac{Δ L}{Δ T} \qquad ( 5 a )$$

The strength of this coefficient will depend on whether the laser is run in constant power mode, where a fast servo actively adjusts the bias current to maintain constant power, or constant current mode, where the bias current is held fixed. In the constant power mode, more electrical energy is applied to the gain chip to compensate for losses. Because the electrical-optical conversion is not 100% efficient, some of this energy turns into heat, which causes a temperature rise. In constant current mode, a similar effect also occurs. As the losses increase, the laser produces less light. The energy that this light would have carried away becomes heat instead. This effect, which also occurs in constant power mode, is substantially weaker.

As with filters, gain changes produce phase shifts (Δn) associated with them. The increase in gain (Δg) is related as a constant times the log of the change in transmission. A new parameter, α, is defined as the negative ratio phase shift divided by the gain increase, as follow:

$${α}_{linewidth} ≡ \frac{- Δ n}{Δ g} \qquad ( 5 b )$$

wherein α has units microns/dB.

The active mode pulling effects that arise from thermal and linewidth changes can be combined into a single parameter.
α≡αₜₕₑᵣₘₐₗ+α_{linewidth} (5c)
Although both effects actively pull the lasing wavelength there are several differences. First the effects act with opposite sign. The thermal effect generally decreases the lasing frequency as the losses increase whereas the linewidth effect generally increases the lasing frequency as the same losses increase. The effects also take effect with different time constants. The gain changes required to generate the linewidth enhancement effects require on the order of a nanosecond to approach equilibrium. The thermal effects take microseconds to milliseconds or more before the temperature substantially responds. The net effect is shown in FIG. 6c, which illustrates the lasing frequency (depicted as ν_{active}), is now shifted even further. The value of alpha may be determined experimentally by fitting the observed frequencies to a modeling equation, described next.

The effect of the passive and active mode pulling effects may be modeled with the equation:

$$\frac{{𝓋}_{final} - {𝓋}_{start}}{\overline{𝓋}} = - \frac{Δ {L}_{applied} - α * log ( \frac{transmission ( {𝓋}_{final} )}{transmission ( {𝓋}_{start} )} )}{L + {L}_{p}} \qquad ( 6 )$$

or more succinctly,

$$\frac{Δ 𝓋}{𝓋} = \frac{Δ L - αΔ log ( T ( 𝓋 ) )}{L + {L}_{p}} \qquad ( 6 a )$$

This equation implicitly defines the dependant variable Δν (or, for example, ν_{active}), which appears on both sides of the equation, as a function of the independent variable ΔL, the change in cavity length.
Critical Transmission Slope

The equations for active mode pulling are inherently implicit: A frequency change causes a transmission change, causing a further frequency change. This effect will run away when the transmission slope through the filter exceeds a critical threshold. This critical transmission point is defined by the derivative of the equation (6a), yielding:

$$\frac{ⅆ 𝓋}{ⅆ {L}_{applied}} = - \frac{1}{α \cdot \frac{ⅆ log T ( 𝓋 )}{ⅆ 𝓋} - ( \frac{L + {L}_{p}}{𝓋} )} \qquad ( 7 )$$

which has a pole at:

$$\frac{ⅆ log T ( 𝓋 )}{ⅆ 𝓋} = \frac{L + {L}_{p}}{α \cdot 𝓋} . \qquad ( 7 a )$$

This relationship is derived from the previous equation (6a) by calculating dν/dL from the above equation (7a) (let ΔL and Δν approach zero) and noting the pole, which arises in the denominator.

Thus, under the condition:

$$\frac{ⅆ log T ( v )}{ⅆ v} < \frac{L + {L}_{p}}{α \cdot v} \qquad ( 7 b )$$

(where the right hand side is negatively valued) a very small (theoretically infinitesimal) change in cavity length (optical path length) causes a macroscopic (significantly larger) change in frequency. Given an intracavity filter with transmission T(ν), a region where the inequality 7b is satisfied may (or may not) exist. The slope of T(ν) will generally increase as the filter FWHM decreases. The laser will not operate at frequencies where the inequality is satisfied. A potential mode at these frequencies is called unstable and lasing will not occur at such an unstable mode even if a potential laser mode exists at that frequency and that potential laser mode has the lowest threshold losses. The laser will operate in the mode with lowest threshold losses that is also stable.

When designing the intracavity filtering used to achieve single longitudinal mode operation in an otherwise multi-longitudinal mode laser, the intracavity filter may also serve other purposes, such as providing the means for frequency locking the laser, as described above. Under this technique, a frequency dither is applied by dithering the cavity length and the peak filter transmission is located by demodulating the resulting output power modulations. The servo maximizes the filter transmission by locating a point where

$$\frac{ⅆ log T ( v )}{ⅆ v} = 0. \qquad ( 8 )$$

To operate such a servo, it is desirable to have a narrow filter FWHM. A narrow FWHM creates a sharper peak, which generates a stronger signal for locking. The noise this signal overcomes is generally optical scatter. Considering the phasors shown in FIG. 5b, the optical scatter (not shown) would be small amplitude phasors adding to the phasor sum. This noise will perturb the effective transmission curve through the filters. The filter will then lock to a new frequency where

$${( \frac{ⅆ log T ( v )}{ⅆ v} )}_{filter} + {( \frac{ⅆ log T ( v )}{ⅆ v} )}_{scatter} = 0 \qquad ( 9 )$$

It is desirable to choose a narrow FWHM to improve the rejection of this noise. If the filter peak is used as the standard against wavelength is measured, then the optical scatter will cause an error in the accuracy with which this standard can be determined.

Strong scatter may also create local maxima away from the global maxima. The peak finding servo may accidentally be caught in such a local maxima. It is desirable to maximize the filter slope (such as selecting a narrower FWHM) so that the filter slope overcomes these local maxima. The teachings leading to equation 5c show that the filter slope has an effective maximum slope that can be used to overcome these local maxima. To reduce the impact of optical scatter, it is desirable to design a laser with an intracavity filter that approaches or achieves the maximum slope available.

It may not be desirable to select a filter FWHM where modes lase on significantly lower threshold modes because they cannot lase in the region denoted by equation 7b. The adjacent mode under the main filter lobe may not be the next lowest threshold mode. The next lowest threshold mode may occur on a laser mode under an adjacent filter mode (see FIG. 2) or on a non-adjacent filter mode under the gain peak. However, if the inequality in equation 7b is exceeded, but not greatly exceeded, one can keep the laser from operating at these distant modes by having sufficient transmission at these adjacent modes relative to the main peak and by making the cavity modes commensurate with the filter modes and by keeping the filter from becoming so narrow that the only available mode under the main filter mode is a very high threshold mode.

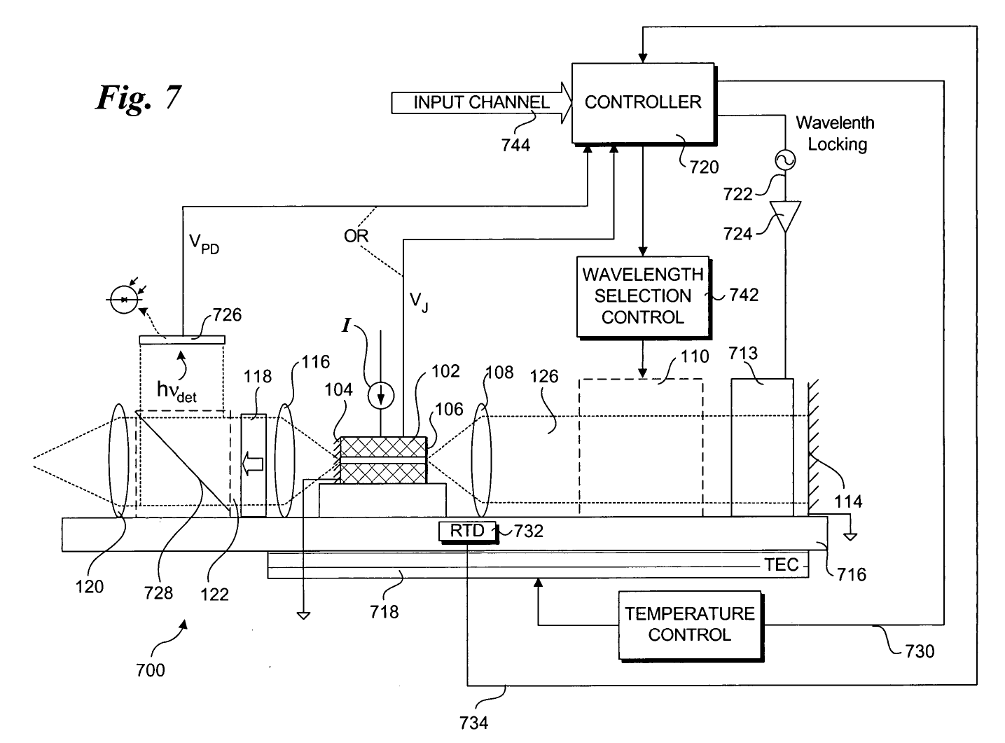

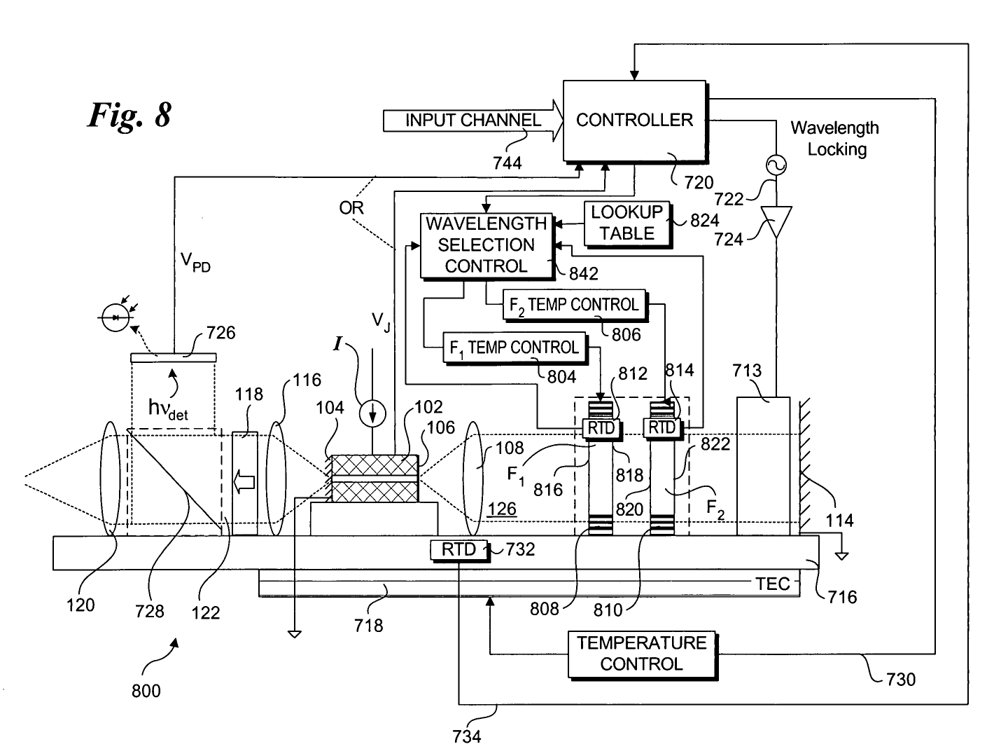

The teachings and principles of the invention disclosed herein may be implemented in ECDL lasers having a general configuration similar to that discussed above with reference to ECDL 100. For example, with reference to FIG. 7, an ECDL 700 in shown including various elements common to ECDL 100 having like reference numbers, such as a gain diode chip 102, lenses 108, 116, and 120, etc. The various optical components of the ECDL 700 are mounted or otherwise coupled to a thermally-controllable base or “sled” 716. In one embodiment, one or more thermal-electric cooler (TEC) elements 718, such as a Peltier element, are mounted on or integrated in sled 716 such that the temperature of the sled can be precisely controlled via an input electrical signal. Due to the expansion and contraction of a material in response to a temperature change, the length of the sled can be adjusted very precisely. Adjustment of the length results in a change in the distance between partially reflective front facet 104 and reflective element 114, which produces a change in the optical path length of the laser cavity. As a result, controlling the temperature of the sled can be used to provide fine adjustment of the frequency of the lasing mode, such as used in the channel-locking mode discussed above.

In general, temperature control of the sled will be used for very fine tuning adjustments, while coarser tuning adjustments will be made by means of tuning filter elements 110. Generally, tuning filter elements may comprise one or more etalons, gratings, prisms or other element or elements that are capable of providing feedback to gain medium 102 along at a selected wavelength or sets of wavelengths. The tuning filter element(s) 110 are controlled by a wavelength selection control block 742, which in turn is coupled to or included as part of a controller 720. In response to an input channel command 744, the controller and/or wavelength selection control block adjust the tuning filter element(s) so as to produce a lasing mode corresponding to the desired channel frequency.

In general, the tunable ECDLs may employ a wavelength-locking (also referred to as channel-locking) scheme so as to maintain the laser output at a selected channel frequency (and thus at a corresponding predetermined wavelength). Typically, this may be provided via a “phase modulation” scheme, wherein the optical path length of the laser cavity is modulated at a relatively low frequency (e.g., 500 Hz-20 KHz) at a small frequency excursion. In one embodiment, an optical path length modulator 713 is employed for this purpose. In response to a modulated wavelength locking excitation signal 722 generated by controller 720 and amplified by an amplifier 724, the optical path length of modulator 713 is caused to modulate, thereby inducing a wavelength modulation and in the laser's output. Generally, the optical path length modulator may comprise an element that changes its optical path length in response to an electrical input, such as a Lithium Niobate (LiNbO3) phase modulator. Lithium Niobate is a material that changes its index of refraction (ratio of the speed of light through the material divided by the speed of light through a vacuum) when a voltage is applied across it. As a result, by providing a modulated voltage signal across the LiNbO3 phase modulator, the optical path length of the external laser cavity can be caused to modulate. Other means of modulating the optical path length of the laser cavity may be employed as well, such as modulating the location of reflective element 114 (e.g., via a MEMS mirror or a reflector coupled to a piezo-electric actuator). Another technique is to employ a gain medium with a phase control section that changes its optical path length in response to an injected current.

As is well-known, when the laser's output has a frequency that is centered on a channel frequency (in accordance with appropriately configured filter elements), the laser intensity is maximized relative to non-centered outputs. As a result, the wavelength modulation produces an intensity modulation having an amplitude indicative of how off-center the lasing mode is. A corresponding feedback signal may then be generated that is received by controller 720 and processed to adjust the overall cavity length via a sled temperature control signal 730.

For example, in the illustrated embodiment of FIG. 7, a photodetector 726 is used to detect the intensity of the laser output. A beam splitter 728 is disposed in the optical path of output beam 122, causing a portion of the output beam light to be redirected toward photodetector 726. In one embodiment, photodetector 726 comprises a photo diode, which generates a voltage charge in response to the light intensity it receives (hνdet). A corresponding voltage VPD is then fed back to controller 720.

Controller 720 includes a digital servo loop (e.g., phase lock loop) that is configured to adjust the temperature of sled 716 such that the amplitude modulation of the light intensity detected at photodectector 726 is minimized, in accordance with a typical intensity vs. frequency curve for a given channel and corresponding filter characteristics. In an optional embodiment, the junction voltage across gain diode chip (VJ) is employed as the intensity feedback signal, rather than VPD. An error signal is then derived by based on the amplitude modulation and phase of VPD or VJ in combination with modulated signal 722. In response to the error signal, an appropriate adjustment in temperature control signal 730 is generated. Adjustment of the sled temperature causes a corresponding change in the overall (continuous) cavity length, and thus the lasing frequency. This in turn results in (ideally) a decrease in the difference between the lasing frequency and the desired channel frequency, thus completing the control loop. To reach an initial condition, or for a second feedback signal, a resistive thermal device (RDT) 732, such as a thermister or thermocouple, may be used to provide a temperature feedback signal 734 to controller 720.

In general, various tuning filter elements and corresponding tuning adjustment techniques may be employed for channel selection purposes. For example, in an ECDL 800 shown in FIG. 14, tuning filter elements 110 comprise first and second tunable filters F₁ and F₂. In one embodiment, filters F₁ and F₂ comprise respective etalons, either made of a solid material or being gas filled. In one embodiment, filter tuning is effectuated by changing the optical path length of each etalon. This, in turn, may be induced by changing the temperature of the etalons.

For example, ECDL 800 now shows further details of an exemplary channel selection subsystem. It is noted that although the wavelength selection control block is shown external to controller 820, the control aspects of this block may be provided by the controller alone. Wavelength selection control block 842 provides electrical outputs 804 and 806 for controlling the temperatures of filters F₁ and F₂, respectively. In one embodiment, a temperature control element is disposed around the perimeter of a circular etalon, as depicted by TECs 808 and 810. Respective RTDs 812 and 814 are employed to provide a temperature feedback signal back to wavelength selection control block 842.

Generally, etalons are employed in laser cavities to provide filtering functions. As discussed above, they essentially function as Fabry-Perot resonators, and provide a filtering function defining a set of transmission peaks in the laser output. The FSR spacing of the transmission peaks is dependent on the distance between the two faces of the etalon, e.g., faces 816 and 818 for filter F₁, and faces 820 and 822 for filter F₂. As the temperatures of the etalons change, the etalon material is caused to expand or contract, thus causing the distance between the faces to change. This effectively changes the optical path length of the etalons, which may be employed to shift the transmission peaks.

The effect of the filters is cumulative. As a result, all lasing modes except for a selected channel lasing mode can be substantially attenuated by lining up a single transmission peak of each filter. In one embodiment, the configurations of the two etalons are selected such that the respective fee spectral ranges of the etalons are slightly different. This enables transmission peaks to be aligned under a Vernier tuning technique similar to that employed by a Vernier scale. In one embodiment, one of the filters, known as a “grid generator,” is configured to have a free spectral range corresponding to a communications channel grid, such as the ITU wavelength grid. This wavelength grid remains substantially fixed by maintaining the temperature of the corresponding grid generator etalon at a predetermined temperature. At the same time, the temperature of the other etalon, known as the channel selector, is adjusted so as to shift its transmission peaks relative to those of the grid generator. By shifting the transmission peaks of the filters in this manner, transmission peaks corresponding to channel frequencies may be aligned, thereby producing a cavity lasing mode corresponding to the selected channel frequency. In another embodiment, the transmission peaks of both the filters are shifted to select a channel.

Generally, either of these schemes may be implemented by using a channel-etalon filter temperature lookup table in which etalon temperatures for corresponding channels are stored, as depicted by lookup table 824. Typically, the etalon temperature/channel values in the lookup table may be obtained through a calibration procedure, through statistical data, or calculated based on tuning functions fit to the tuning data. In response to input channel selection 744, the corresponding etalon temperatures are retrieved from lookup table 824 and employed as target temperatures for the etalons using appropriate temperature control loops, which are well-known in the art.

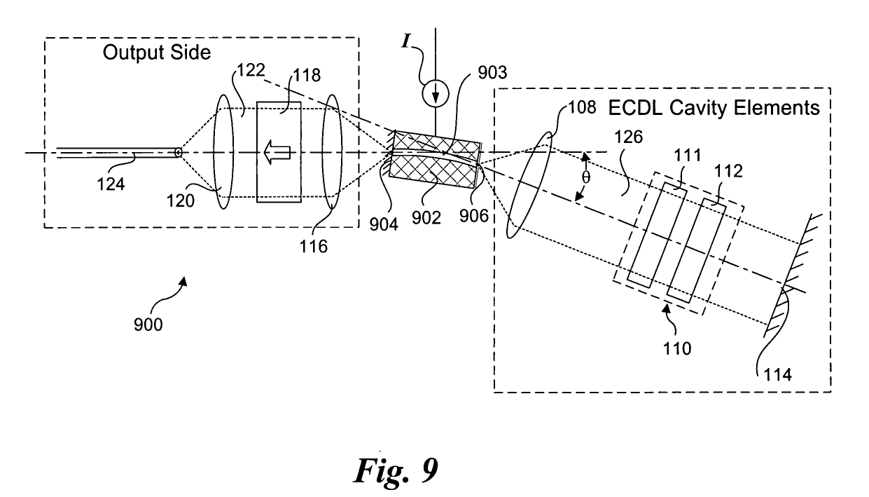

An ECDL 900 illustrating an exemplary configuration of an ECDL that employs a gain medium chip 902 with a bent waveguide 903 is shown in FIG. 9. The gain medium chip also includes a partially-reflective front facet 904 and a non-reflective rear facet 906. In general, the various ECDL cavity elements and output side elements are similar to those discussed in the prior embodiments that employ a gain medium chip having a linear waveguide, except that there is an angle θ between the centerlines of both sets of elements. In one embodiment θ is approximately 20 degrees.

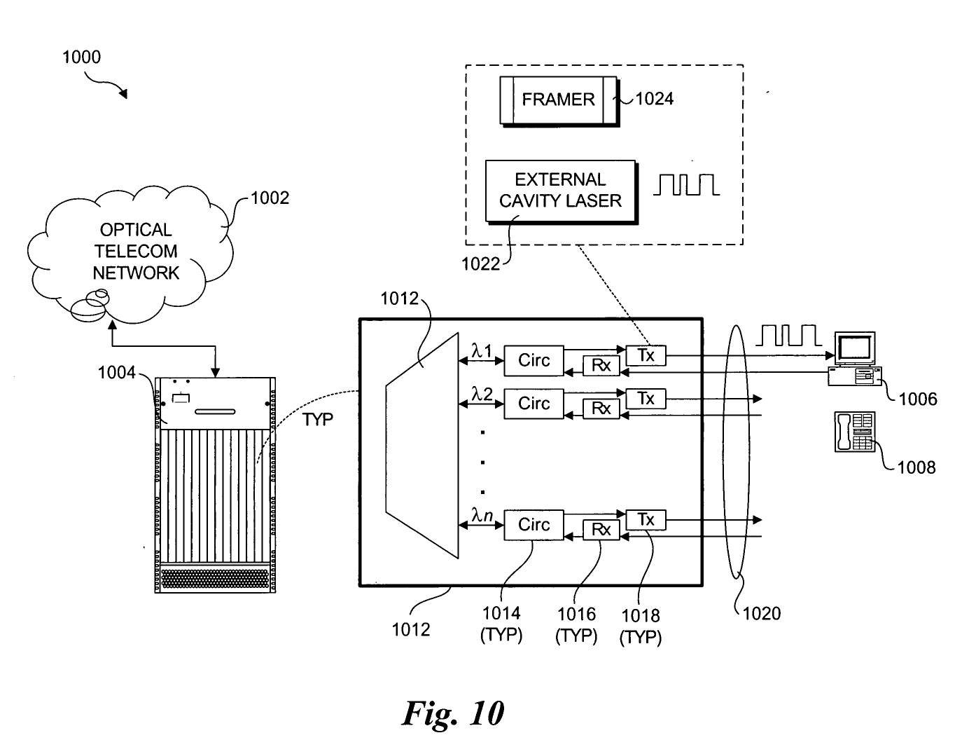

FIG. 10 shows a communication system 1000 in accordance with an embodiment of the invention in which an optical network is coupled to a plurality of data and voice subscribers lines by an optical multiplexer/demultiplexer utilizing ECLT's tunable to the center frequency of any of the WDM channels on the optical network. The communication system includes an optical network 1002, a network switch 1004, a data terminal 1006, and a voice terminal 1008. The modulated data may be carried on a number of channels in multiple access protocols including but not limited to: wavelength division multiplexing (WDM), dense wavelength division multiplexing (DWDM), frequency division multiple access (FDMA), etc. Currently, this expansion of bandwidth is primarily being accomplished by WDM, in which separate subscriber/data session may be handled concurrently on a single optical fiber by means of modulation of each of those subscriber datastreams on different portions of the light spectrum. The precise center frequencies of each channel are specified by standard setting organizations such as the International Telecommunications Union (ITU). The center frequencies are set forth as part of a wavelength grid that defines the center frequencies and spacing between channels. Typically, the grid spacing is even and occurs at integer multiples of a selected fundamental frequency.

Network switch 1004 provides network-switching operations, as is well-known in the art. This is facilitated by optical transceivers that are mounted on fiber line cards 1010. Each fiber line card includes a multi-state multiplexer/demultipleker (mux/demux) 1012, a circulator bank including circulators 1014, a receiver bank including receivers 1016, and a transmitter bank including transmitters 1018. The mux/demux is a passive optical device that divides wavelengths (or channels) from a multi-channel optical signal, or combines various wavelengths (or channels) on respective optical paths into one multi-channel optical signal depending on the propagation direction of the light.

In the receive mode, after de-multiplexing, each individual channel is passed via a corresponding circulator 1014 within the circulator bank to a corresponding receiver 1016 in the receiver bank. Each receiver 1016 includes a narrow bandpass photodetector, framer, and decoders (not shown). Switches (not shown) couple the receiver over a corresponding one of subscriber lines 1020 to a voice or data terminal 1006 or 1008, respectively.

In the transmit mode, each line card transmitter bank includes a bank of lasers 1022, including n (e.g., 128) ECLs radiating light at one of the selected center frequencies of each channel of the telecommunications wavelength grid. The wavelength range of current ITU-defined grids is 1525-1575 nm. Each subscriber datastream is optically modulated onto the output beam of a corresponding ECL having a construction and operation in accordance with the embodiments of the invention discussed above. A framer 1024 permits framing, pointer generation and scrambling for transmission of data from the bank of ECLs and associated drivers. The modulated information from each of the lasers is passed via a corresponding circulator into mux/demux 1012, which couples the output to a single optical fiber for transmission. The operation of the fiber line card in the embodiment shown is duplex, meaning that bi-directional communications are possible.

Although described above in view of ECDLs, the principles and teachings herein may also be applied to external cavity lasers (ECLs) in a similar manner. Furthermore, the principles and teachings may be applied to single-wavelength non-tunable ECLs and ECDLs. For example, in the embodiment of FIG. 1, filter 110 would comprise an etalon having a FWHM value selected in view of the passive and active mode pulling effects, as modeled by equation 7b.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. An external cavity laser, comprising:
a gain medium, to emit a plurality of photons in response to an electrical input;
an optical cavity optically coupled to the gain medium, in which said plurality of photons resonate in accordance with a plurality of lasing modes, the gain medium and the optical cavity defining an optical path length;
an optical filter, disposed in the optical cavity and configured to achieve a single longitudinal lasing mode operation,
wherein the optical filter has a filter transmission slope defined by a change in optical transmission with respect to a change in optical frequency that approaches or achieves a critical transmission slope at which an very small change in the optical path length causes a significantly larger change in optical frequency of the single longitudinal lasing mode.

2. The external cavity laser of claim 1, wherein the critical transmission slope is determined in view of passive and active mode pulling effects.

3. The external cavity laser of claim 2, wherein the critical transmission slope is determined as a function of the inequality:
$$\frac{ⅆ log T ( v )}{ⅆ v} < \frac{L + {L}_{p}}{α \cdot v}$$
wherein ν is frequency, T(ν) is the filter's transmission function versus frequency ν, L is the cavity length, L_{P} is a passive mode pulling length scale factor, and α is defined by
α≡αₜₕₑᵣₘₐₗ+α_{linewidth}
wherein
$$\begin{matrix}{α}_{thermal} ≡ \frac{Δ L}{Δ T} \\ and \\ {α}_{linewidth} ≡ \frac{- Δ n}{Δ g}\end{matrix}$$
wherein ΔL is a change in cavity length, ΔT is a change in the gain medium temperature, Δn is a phase shift, and Δg is a change in gain for the gain medium.

4. The external cavity laser of claim 1, wherein the filter comprises an etalon.

5. The external cavity laser of claim 1, wherein the laser comprises a tunable laser, and the optical filter comprises first and second etalons that are independently tuned to select an optical communication channel by aligning a transmission peak of the first etalon with a transmission peak of the second etalon.

6. The external cavity laser of claim 5, wherein the laser employs a Vernier tuning mechanism including the first and second filters having respective sets of transmission peaks having slightly different free spectral ranges and similar finesses, and wherein tuning is performed by shifting the set of transmission peaks of the second optical filter relative to the set of transmission peaks of first optical filter to align a single transmission peak of each of the first and second sets of transmission peaks.

7. The external cavity laser of claim 5, wherein the second optical filter has a plurality of transmission peaks corresponding to a standard optical communication channel grid.

8. An external cavity diode laser (ECDL), comprising:
a base;
a laser diode gain chip operatively coupled to the base having a partially-reflective front facet, to emit light in response to an electrical input;
a reflective element positioned parallel with the partially-reflective front facet and operatively coupled to the base, said reflective element and the partially-reflective front facet defining a laser cavity having an optical path length; and
a first etalon disposed in the laser cavity and operatively coupled to the base, the first etalon comprising an optical filter configured to achieve a single longitudinal lasing mode operation,
wherein the first etalon has a filter transmission slope defined by a change in optical transmission with respect to a change in optical frequency that approaches or achieves a critical transmission slope at which a very small change in the optical path length causes a significantly larger change in optical frequency of the single longitudinal lasing mode.

9. The ECDL of claim 8, wherein the critical transmission slope is determined in view of passive and active mode pulling effects.

10. The ECDL of claim 9, wherein the critical transmission slope is determined as a function of the inequality:
$$\frac{ⅆ log T ( v )}{ⅆ v} < \frac{L + {L}_{p}}{α \cdot v}$$
wherein ν is frequency, T(ν) is the filter's transmission characteristic versus frequency, L is the cavity length, L_{P} is a passive mode pulling length scale factor, and α is defined by
α≡αₜₕₑᵣₘₐₗ+α_{linewidth}
wherein
$$\begin{matrix}{α}_{thermal} ≡ \frac{Δ L}{Δ T} \\ and \\ {α}_{linewidth} ≡ \frac{- Δ n}{Δ g}\end{matrix}$$
wherein ΔL is a change in cavity length, ΔT is a change in the gain medium temperature, Δn is a phase shift, and Δg is a change in gain for the gain medium.

11. The ECDL of claim 8, wherein the ECDL comprises a tunable ECDL, further comprising:
a second etalon, disposed in the laser cavity; and
a tuning mechanism, coupled to each of the first and second etalon, the tuning mechanisms employed to tune the ECDL output to a selected optical communication channel by tuning at least one of the first and second etalons to align a transmission peak of the first etalon with a transmission peak of the second etalon.

12. The ECDL of claim 11, wherein the second etalon has a plurality of transmission peaks corresponding to a standard optical communication channel grid.

13. The ECDL of claim 8, wherein the first etalon is made of a material that changes its index of refraction in response to an electrical input.

14. The ECDL of claim 8, wherein the first etalon is made of a material that changes its index of refraction in response to change in temperature.

15. The ECDL of claim 8, wherein the laser diode gain chip includes one of a curved or bent waveguide.

16. The ECDL of claim 8, wherein the laser diode gain chip comprises a Fabry-Perot resonator including a rear facet disposed opposite the front facet, and wherein the rear facet is coated with an anti-reflective coating that substantially reduces internal reflections at the rear facet.

17. A method for configuring an external cavity laser including a gain medium coupled to an external optical cavity and an intracavity filter, comprising:
determining a passive mode pulling effect on the intracavity filter;
determining an active mode pulling effect on the external cavity laser due to an interaction between the intracavity filter and the gain medium; and
selecting a full-width half maximum (FWHM) value for the intracavity filter in view of the passive and active mode pulling effect.

18. The method of claim 17, wherein the operation of determining the passive mode pulling effect on the intracavity filter is performed by mathematically modeling a passive mode pulling effect.

19. The method of claim 17, wherein the operation of determining the active mode pulling effect on the external cavity laser is performed by mathematically modeling an active mode pulling effect.

20. The method of claim 17, wherein the external cavity laser has an optical path length and wherein the FWHM of the intracavity filter is selected such that the intracavity filter has a filter transmission slope defining a change in optical transmission with respect to a change in optical frequency that approaches or achieves a critical transmission slope at which a very small change in the optical path length causes a significantly larger change in optical frequency of the single longitudinal lasing mode.

21. The method of claim 20, wherein the critical transmission slope is determined as a function of the inequality:
$$\frac{ⅆ log T ( v )}{ⅆ v} < \frac{L + {L}_{p}}{α \cdot v}$$
wherein ν is frequency, T(ν) is the filter's transmission characteristic versus frequency, L is the cavity length, L_{P} is a passive mode pulling length scale factor, and α is defined by
α≡αₜₕₑᵣₘₐₗ+α_{linewidth}
wherein
$$\begin{matrix}{α}_{thermal} ≡ \frac{Δ L}{Δ T} \\ and \\ {α}_{linewidth} ≡ \frac{- Δ n}{Δ g}\end{matrix}$$
wherein ΔL is a change in cavity length, ΔT is a change in the gain medium temperature, Δn is a phase shift, and Δg is a change in gain for the gain medium.

22. The method of claim 17, wherein the FWHM of the intracavity filter is selected such that the external cavity laser will operate in a single longitudinal lasing mode with the lowest threshold loses that is also stable.

23. A telecommunication switch comprising:
one or more fiber line cards, at least one of the fiber line cards including,
a multi-stage multiplexer/demultiplexer;
a circulator bank, comprising a plurality of circulators operatively coupled to the multi-stage multiplexer/demultiplexer;
a receiver bank, comprising a plurality of receivers operatively coupled to respective circulators; and
a transmitter bank, comprising a plurality of transmitters operatively coupled to respective circulators, each transmitter comprising at tunable external cavity diode laser (ECDL), comprising:
a base;
a laser diode gain chip operatively coupled to the base having a partially-reflective front facet, to emit light in response to an electrical input;
a reflective element positioned parallel with the partially-reflective front facet and operatively coupled to the base, said reflective element and the partially-reflective front facet defining a laser cavity; and
a first etalon disposed in the laser cavity and operatively coupled to the base, the first etalon comprising an optical filter configured to achieve a single longitudinal lasing mode operation,
wherein the first etalon has a filter transmission slope defining a change in optical transmission with respect to a change in optical frequency that approaches or achieves a critical transmission slope at which a very small change in the optical cavity length of the laser cavity causes a significantly larger change in optical frequency of the single longitudinal lasing mode.

24. The telecommunications switch of claim 23, wherein in at least one ECDL a Vernier tuning mechanism is employed including the first etalon and a second etalon, the first and second etalons having respective sets of transmission peaks having slightly different free spectral ranges and similar finesses, and wherein tuning is performed by shifting the set of transmission peaks of the second optical filter relative to the set of transmission peaks of first optical filter to align a single transmission peak of each of the first and second sets of transmission peaks.

25. The telecommunications switch of claim 23, wherein in at least one ECDL the critical transmission slope is determined in view of passive and active mode pulling effects.
